(19) United States
(12) Patent Application Publication
(10) Pub. No.: US 2014/0378257 A1
(43) Pub. Date: Dec. 25, 2014

(54) VARIABLE SPEED DRIVE SYSTEM FOR DRIVEN EQUIPMENT

(71) Applicant: SOLAR TURBINES INCORPORATED, San Diego, CA (US)

(72) Inventor: Robert C. White, San Diego, CA (US)

(21) Appl. No.: 13/940,797

(22) Filed: Jul. 12, 2013

(51) Int. Cl. F16H 3/72

(52) U.S. Cl. CPC F16H 3/725; Y10S 903/902
USPC 475/5; 180/65.265; 903/902

(57) ABSTRACT

A variable speed drive system for a driven equipment includes a fixed speed prime mover, a differential, and a variable speed prime mover. The differential includes a power output component, a first input component, and a second input component. The power output component is coupled to the driven equipment. The first input component is coupled to the fixed speed prime mover and disposed in rotational engagement with the power output component. The second input component is disposed in rotational engagement with the first input component and the power output component. The variable speed prime mover is coupled to the second input component. The variable speed prime mover is configured to modulate a rotational speed of the power output component by modulating a speed of the second input component.

### TECHNICAL FIELD

The present disclosure relates to a drive system for a driven equipment, and more particularly to a variable speed drive system for the driven equipment.

### BACKGROUND

Many applications may employ large variable frequency drives on motors to vary a rotational speed of driven equipment such as pumps, compressors or other types of driven equipment. The variation to the rotational speed of the driven equipment may range based on speed requirements of a specific application. However, variable frequency drives are typically expensive and become costly when implemented in larger sizes or capacities for larger applications.

In some cases, conventionally known systems for varying the rotational speed of driven equipment may include hydrodynamic transmissions with torque converters and/or clutches therein. For example, U.S. Pat. No. 4,726,255 (hereinafter referred to as '255 patent) relates to a power transmission system that serves to drive a variable-speed processing machine normally in a lower speed range and if necessary in an upper speed range.

The '255 patent discloses the following elements disposed coaxially to one another: An input shaft connected by means of a hydrodynamic adjustable coupling to an intermediate shaft to rotate the impeller pump of an adjustable hydrodynamic torque converter. Its turbine wheel rotates with a breakable override shaft. The intermediate shaft and the override shaft are connected to an output shaft by means of a differential gear.

### SUMMARY

In one aspect, the present disclosure discloses a variable speed drive system for a driven equipment. The variable speed drive system includes a fixed speed prime mover, a differential, and a variable speed prime mover. The differential includes a power output component, a first input component, and a second input component. The power output component is coupled to the driven equipment. The first input component is coupled to the fixed speed prime mover and disposed in rotational engagement with the power output component. The second input component is disposed in rotational engagement with the first input component and the power output component. The variable speed prime mover is coupled to the second input component. The variable speed prime mover is configured to modulate a rotational speed of the power output component by modulating a speed of the second input component.

In another aspect, the present disclosure discloses a variable speed electric drive system for a compressor. The variable speed electric drive system includes a first motor, a differential, and a second motor. The differential includes an output gear, a first input gear, and a second input gear assembly. The output gear is coupled to the compressor. The first input gear is coupled to the first motor and disposed in rotational engagement with the output gear. The second input gear assembly is disposed in rotational engagement with the first input gear and the output gear. The second motor is coupled to the second input gear assembly. The second motor is configured to modulate a rotational speed of the output gear by modulating a speed of the second input gear assembly.

In another aspect, the present disclosure discloses a method of modulating a rotational speed of a driven equipment. The method includes driving a first input component of a differential at a speed pre-determined by a fixed speed prime mover. The method further includes rotating a power output component of the differential at the pre-determined speed by the driven first input component, the power output component coupled to the driven equipment. The method further includes driving a second input component disposed in rotational engagement with the first input component and the power output component by a variable speed prime mover such that the speed of the power output component pre-determined by the driven first input component is modulated.

Other features and aspects of this disclosure will be apparent from the following description and the accompanying drawings.

### BRIEF DESCRIPTION OF THE DRAWINGS

FIG. 1 is a schematic of an exemplary variable speed drive system, in accordance with an embodiment of the present disclosure;

FIG. 2 is a diagrammatic view of an exemplary variable speed electric drive system configured to drive an exemplary compressor;

FIGS. 3-4 are diagrammatic views of the variable speed electric drive system in different modes of operation; and

FIG. 5 is a method of modulating a rotational speed of a driven equipment.

### DETAILED DESCRIPTION

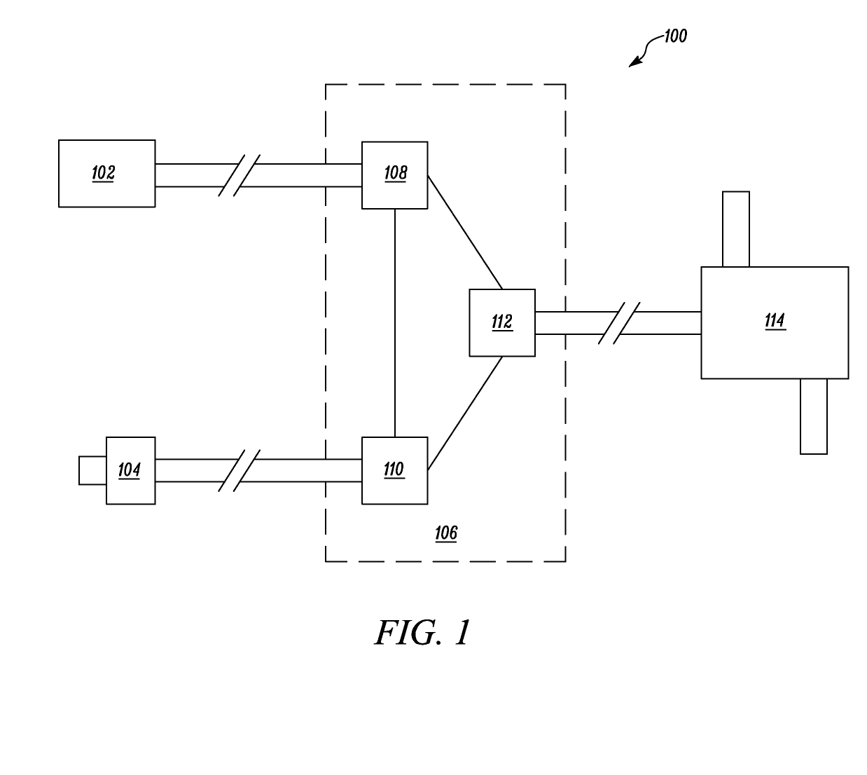

The present disclosure relates to a variable speed drive system for a driven equipment. FIG. 1 shows a schematic of the variable speed drive system 100, in which disclosed embodiments may be implemented. The variable speed drive system 100 includes a fixed speed prime mover 102. In an embodiment, the fixed speed prime mover 102 may be an electric motor. In an alternative embodiment, the fixed speed prime mover 102 may be an engine for example, a reciprocating engine, or a rotary engine such as a Wankel engine.

The variable speed drive system 100 further includes a variable speed prime mover 104. In an embodiment, the variable speed prime mover 104 may be an electric motor. In an alternative embodiment, the variable speed prime mover 104 may be an engine for example, a reciprocating engine, or a rotary engine such as a gas turbine engine. A size and a power output rating of the variable speed prime mover 104 may be smaller than a size and a power output rating of the fixed speed prime mover 102.

The variable speed drive system 100 further includes a differential 106. The differential 106 includes a first input component 108, and a second input component 110 disposed in rotational engagement with the first input component 108. Although the differential 106 is disclosed to include the first input component 108, and the second input component 110, it is to be noted that first input component 108, and the second input component 110 are merely exemplary in nature and hence, non-limiting of this disclosure. The differential 106 may include any number and type of components such as input components, output components, or idling components therein depending on the type of differential and a number of prime movers employed in the variable speed drive system 100.

The fixed speed prime mover 102 is coupled to the first input component 108 of the differential 106. The variable speed prime mover 104 is coupled to the second input component 110 of the differential 106. The differential 106 further includes a power output component 112 in rotational engagement with the first input component 108 and the second input component 110. The power output component 112 is coupled to the driven equipment 114.

The first input component 108 and the second input component 110 may be rotatable relative to each other. The first and the second input components 108, 110 may be configured to rotate based on individual speeds of the fixed speed prime mover 102 and the variable speed prime mover 104 respectively. The power output component 112 may be configured to rotate at a speed based on a relative speed and directions of rotation of the fixed and variable speed prime movers 102, 104.

The variable speed prime mover 104 is configured to modulate a rotational speed of the power output component 112 by modulating the speed of the second input component 110. The fixed speed prime mover 102 rotates the first input component 108 that subsequently drives the power output component 112 at the speed pre-determined by the fixed speed prime mover 102. Thereafter, rotation of the second input component 110 by the variable speed prime mover 104 may modulate the speed pre-determined for the power output component 112 by the fixed speed prime mover 102.

In an embodiment, the variable speed prime mover 104 may be configured to modulate the rotational speed of the power output component 112 within a range of ±30% of a speed pre-determined by the fixed speed prime mover 102.

In an embodiment, the differential 106 may be embodied as a simple planetary gear set. In an alternative embodiment, the differential 106 may be embodied as a compound planetary gear set. In an exemplary embodiment, the compound planetary gear set may be employed when substantially low gear ratios are required in the differential 106 to accomplish a narrow range of modulation to the rotational speed of the power output component 112.

In an example, a speed pre-determined for the power output component 112 by the fixed speed prime mover 102 may be 1800 rpm, and a substantially narrow range of modulation, say ±10%, may be required to the speed of the power output component 112. One way of accomplishing the narrow range of modulation, i.e. ±10% may be to use the compound planetary gear set disclosed herein as the differential 106. Further, the variable speed prime mover 104 may be selected such that the variable speed prime mover 104 together with the differential 106 accomplish ±10% modulation to the speed of the power output component 112. Hence, it may be noted that a type of the differential 106, and a size and power rating of the variable speed prime mover 104 may change based on specific requirements of an application, and the modulation required therein. Therefore, a scope of implementation of the variable speed drive system 100 is not limited to the specific embodiments disclosed herein, but may extend to include other types of differentials known in the art.

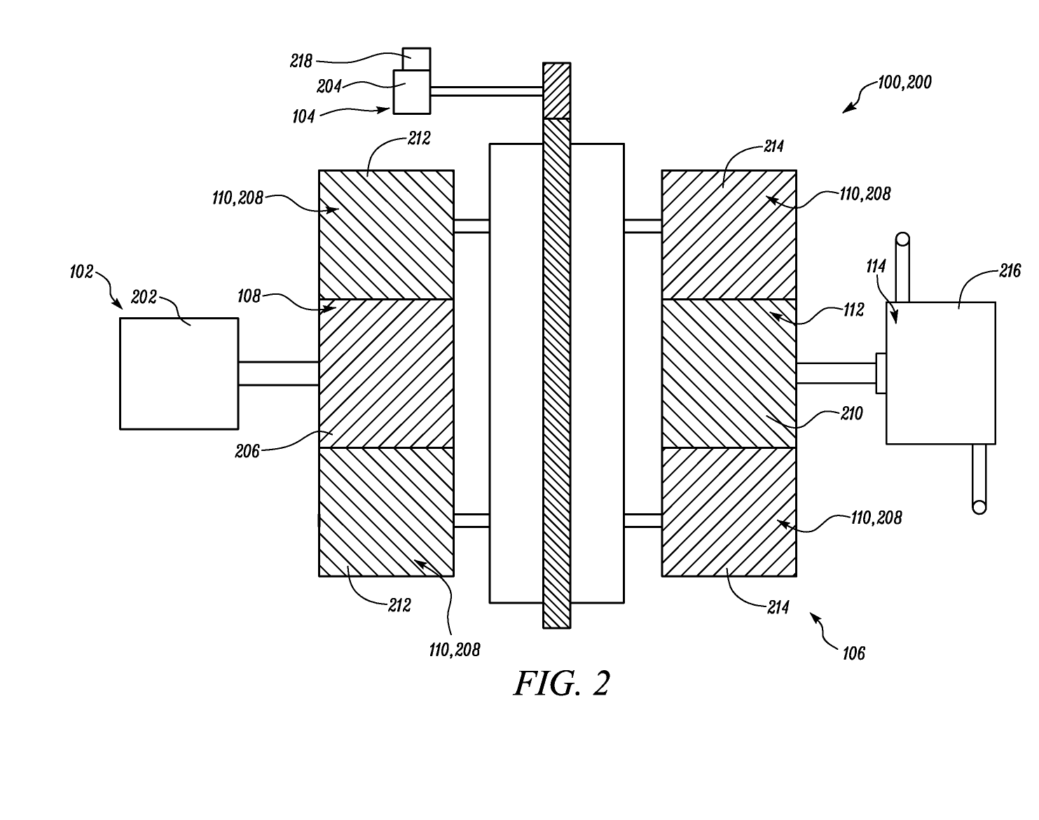

In an embodiment as shown in FIG. 2, the variable speed drive system 100 may embody a variable speed electric drive system 200. The fixed speed prime mover 102 may embody a first motor 202. The variable speed prime mover 104 may embody a second motor 204. The first input component 108 may embody a first input gear 206. The second input component 110 may embody a second input gear assembly 208. The power output component 112 of the differential 106 may embody an output gear 210 disposed in rotational engagement with the first input gear 206 and the second input gear assembly 208. The second input gear assembly 208 may be an epicyclic planetary gear set including two or more planet gears 212, 214 disposed in mesh with the first input gear 206 and the output gear 210 respectively.

As shown in FIG. 2, the driven equipment 114 may embody a compressor 216. The compressor 216 is coupled to the output gear 210. However, in other embodiments, any type of driven equipment may be coupled to the output gear 210. The driven equipment 114 may be, but not limited to, pumps, blowers, fans or any other type of driven equipment commonly known in the art.

The first motor 202 may be a fixed speed synchronous motor supplied with alternating current (AC) of a pre-determined frequency, for example, 60 hertz (Hz). The first motor 202 may rotate with a speed corresponding to the pre-determined frequency. The variable speed electric drive system 200 may further include a variable frequency drive 218 coupled to the second motor 204. The variable frequency drive 218 may be supplied with the AC having the pre-determined frequency. The variable frequency drive 218 may be configured to modulate the pre-determined frequency such that a modulated frequency of the AC is input to the second motor 204. Therefore, the variable frequency drive 218 may be configured to vary a speed of the second motor 204.

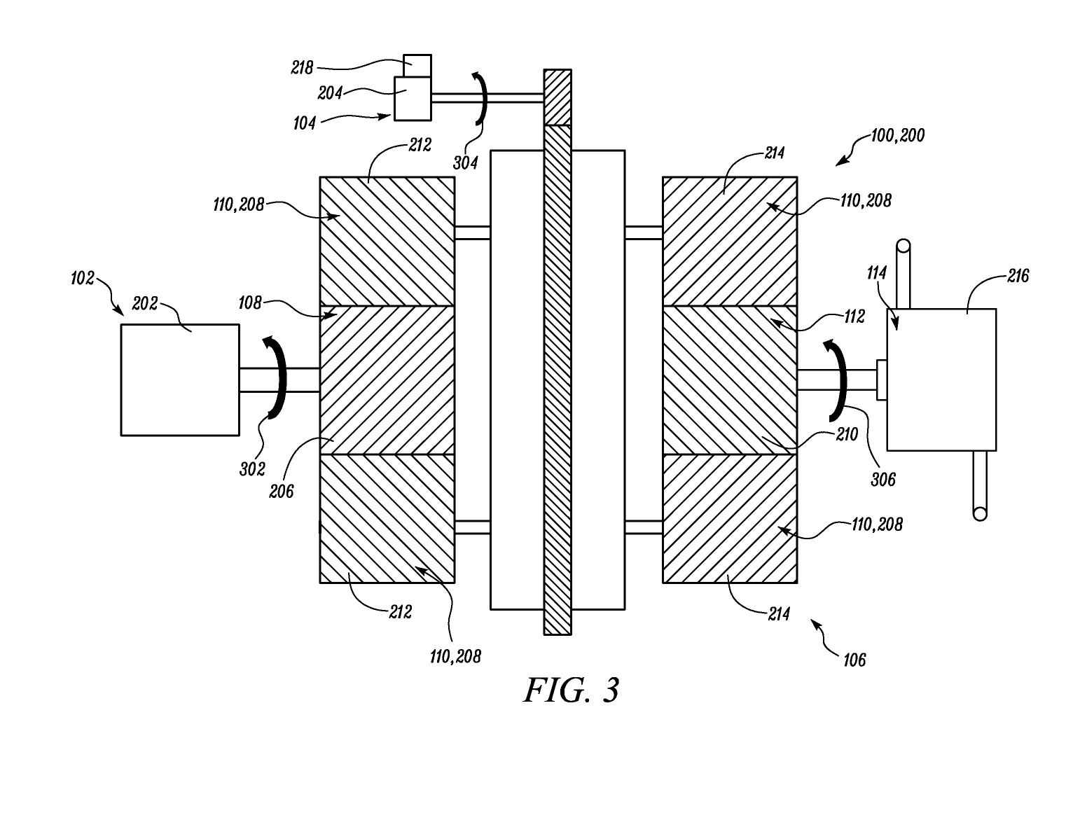

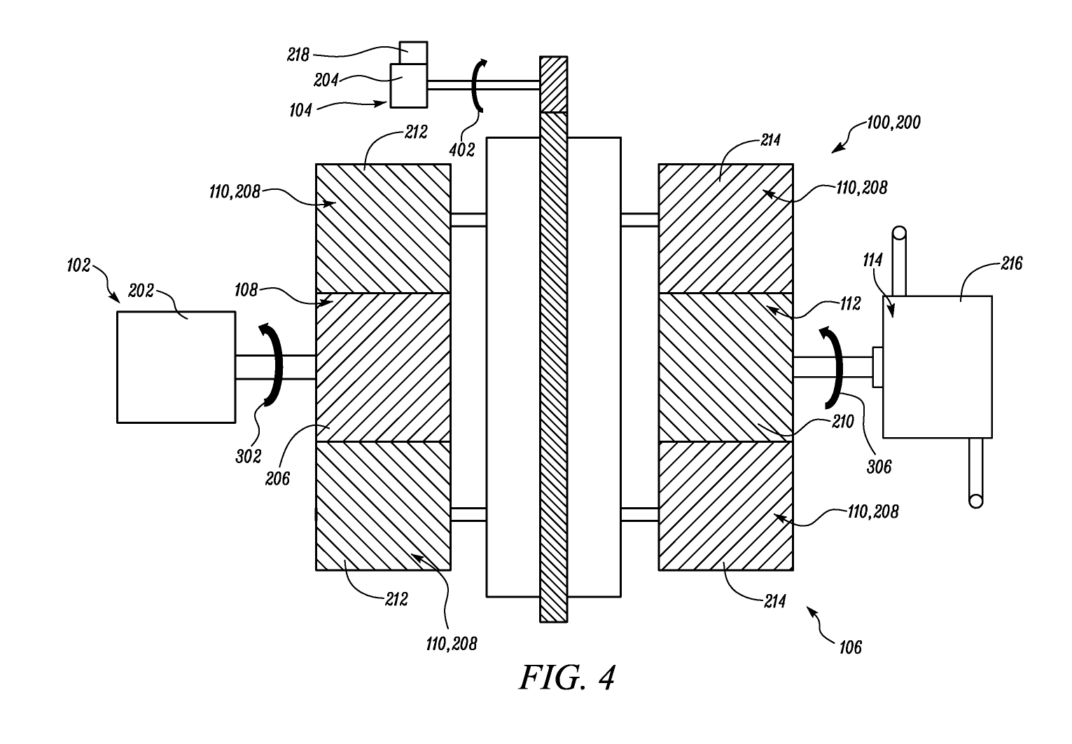

As shown in FIGS. 3-4, the first motor 202 may be configured to rotate uni-directionally, for example, in a clockwise direction 302. The second motor 204 may be configured to rotate bi-directionally, for example, in a clockwise direction 304 as shown in FIG. 3, or in a counter-clockwise direction 402 as shown in FIG. 4.

Referring to FIG. 3, the second motor 204 may be configured to rotate in a direction of rotation of the first motor 202 in order to increase a rotational speed of the output gear 210. Referring to FIG. 4, the second motor 204 may be configured to rotate in a direction opposite to a direction of rotation of the first motor 202 in order to decrease a rotational speed of the output gear 210. The rotation of the output gear 210 and the compressor 216 may be independent of the individual directions 302, 304, or 402 of the first motor 202 and the second motor 204 respectively. Therefore, the rotation of the output gear 210 and the compressor 216 may be unidirectional, for example, in a clockwise direction 306 as shown in FIGS. 3-4. Further, the speed of the second motor 204 may be modulated by the variable frequency drive 218. The planet gears 214 may rotate at a speed depending on the relative speed and direction of rotation of the first input gear 206 and the planet gears 212 and thus, modulate the rotational speed of the compressor 216.

The second motor 204 may be configured to modulate the rotational speed of the output gear 210 within a range of ±30% of the speed pre-determined by the fixed speed prime mover 102. In one embodiment, the rotational speed of the compressor 216 may be increased by 30% of the speed pre-determined by the fixed speed prime mover 102. In another embodiment, the rotational speed of the compressor 216 may be decreased by 30% of the speed pre-determined by the fixed speed prime mover 102. Although it is disclosed herein that the rotational speed of the compressor 216 may be modulated within the range of ±30% of the speed pre-determined by the fixed speed prime mover 102, the modulation of the rotational speed of the compressor 216 may be defined by any even or uneven range, for example, +10% and −20%, or ±20% based on specific requirements of an application. Further, a person having ordinary skill in the art may acknowledge that the modulation of the rotational speed of the compressor 216 may depend on the size and power rating of the second motor 204 relative to the size and power rating of the first motor 202.

### INDUSTRIAL APPLICABILITY

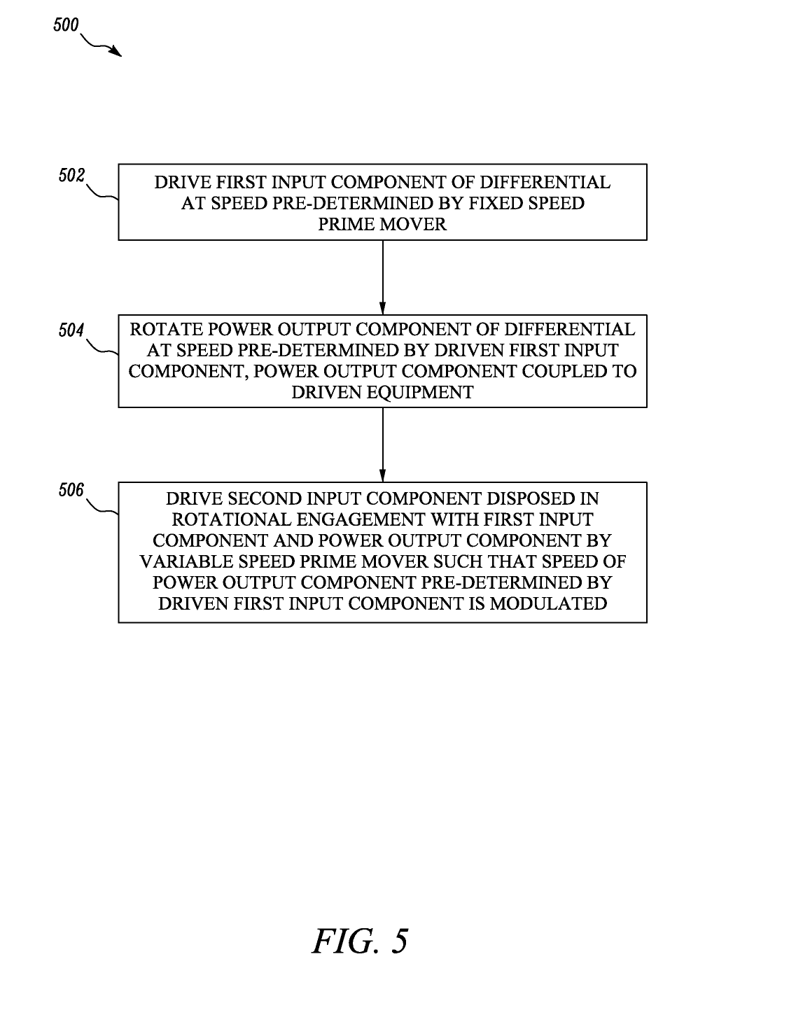

FIG. 5 shows a method 500 of modulating the rotational speed of the driven equipment 114. At step 502, the method 500 includes driving the first input component 108 of the differential 106 at the speed pre-determined by the fixed speed prime mover 102. At step 504, the method 500 further includes rotating the power output component 112 of the differential 106 at the speed pre-determined by the driven first input component 108.

At step 506, the method 500 further includes driving the second input component 110 disposed in rotational engagement with the first input component 108 and the power output component 112 by the variable speed prime mover 104 such that the speed of the power output component 112 pre-determined by the driven first input component 108 is modulated. In an embodiment, driving the second input component 110 includes rotating the second input component 110 in the direction of rotation of the fixed speed prime mover 102 to increase the speed of the power output component 112. In another embodiment, driving the second input component 110 includes rotating the second input component 110 in the direction opposite to the direction of rotation of the fixed speed prime mover 102 to decrease speed of the power output component 112.

In an embodiment, the method 500 further includes modulating the rotational speed of the power output component 112 by the second input component 110 within the range of ±30% of the speed pre-determined by the fixed speed prime mover 102. Although the present disclosure discloses modulating the speed of the power output component 112 within the range of ±30% of the speed pre-determined by the fixed speed prime mover 102, it is to be noted that other ranges may be contemplated by a person having ordinary skill in the art based on specific application requirements and the operating parameters of the driven equipment 114 associated with the application.

Many applications typically require a variation in rotational speed of the driven equipment employed therein. The variation in rotational speed of the driven equipment may cause an end result such as, for example, flow-rate, displacement, speed, power, from the driven equipment to vary in magnitude. The variable speed drive system 100 of the present disclosure may serve to accomplish the aforesaid variation in the end result from the driven equipment 114. In an exemplary embodiment of the present disclosure, the variable speed electric drive system 200 may be configured to vary a compression ratio within the compressor 216.

Conventional systems known to accomplish variation in the rotational speed of the driven equipment typically include hydrodynamic transmissions with torque converters and/or clutches. However, these torque converters and clutches may be susceptible to wear during operation and hence, may be characterized with efficiency losses over a prolonged period of time. Further, for an application requiring modulation of speed output, the torque converters of the conventional systems may have to be redesigned or modified to fit the power and speed requirements of the application. The redesigning or modifications to such components may be expensive and entail costs.

The variable speed drive system 100 of the present disclosure may do away with use of parts or components susceptible to wear during operation. The variable speed drive system 100 may be robust in construction to withstand operational conditions for a prolonged period of time. Further, time, effort and costs previously incurred in maintenance, repairs, and/or replacement of the wear-prone parts or components of the conventional systems may be avoided. Consequently, a profitability associated with operating the driven equipment 114 by the variable speed drive system 100 may be increased.

Further, some conventional systems employ large variable frequency drives on motors to vary a rotational speed of the driven equipment. However, variable frequency drives are typically expensive and hence, become costly when implemented in larger sizes or capacities for larger applications.

The variable speed drive system 100 of the present disclosure employs the fixed speed prime mover 102 and the variable speed prime mover 104. In a case of a large application requiring large power outputs from prime movers, the fixed speed prime mover 102 may be made large in size and power rating to drive the driven equipment 114, while the variable speed prime mover 104 may be made small to accomplish the required variation in speed of the driven equipment 114. Therefore, employing the variable speed drive system 100 of the present disclosure may result in a reduced cost as compared to employing a single large variable frequency drive.

Further, flexibility to use small sized motors off-the-shelf and form the variable speed prime mover 104 may avoid time, effort and expense previously incurred in modifying or redesigning the torque converters. Furthermore, costs associated with employing large variable frequency drives or large variable speed prime movers may be mitigated.

While aspects of the present disclosure have been particularly shown and described with reference to the embodiments above, it will be understood that various additional embodiments may be contemplated by the modification of the disclosed machine, systems and methods without departing from the spirit and scope of what is disclosed. Such embodiments should be understood to fall within the scope of the present disclosure as determined based upon the claims and any equivalents thereof.

I claim:

1. A variable speed drive system for a driven equipment, the system comprising:
a fixed speed prime mover;
a differential comprising:
a power output component coupled to the driven equipment;
a first input component coupled to the fixed speed prime mover and disposed in rotational engagement with the power output component; and
a second input component disposed in rotational engagement with the first input component and the power output component; and
a variable speed prime mover coupled to the second input component, the variable speed prime mover configured to modulate a rotational speed of the power output component by modulating a speed of the second input component.

2. The system of claim 1, wherein the fixed speed prime mover and the variable speed prime mover is one of an engine and a motor.

3. The system of claim 1, wherein the variable speed prime mover is configured to rotate bi-directionally.

4. The system of claim 1, wherein a size and a power output rating of the variable speed prime mover is smaller than a size and a power output rating of the fixed speed prime mover.

5. The system of claim 1, wherein the variable speed prime mover is configured to rotate in a direction of rotation of the fixed speed prime mover to increase the rotational speed of the power output component.

6. The system of claim 1, wherein the variable speed prime mover is configured to rotate in a direction opposite to a direction of rotation of the fixed speed prime mover to decrease the rotational speed of the power output component.

7. The system of claim 1, wherein the variable speed prime mover is configured to modulate a rotational speed of the power output component within a range of ±30% of a speed pre-determined by the fixed speed prime mover.

8. A variable speed electric drive system for a compressor, the system comprising:
a first motor;
a differential comprising:
an output gear coupled to the compressor;
a first input gear coupled to the first motor and disposed in rotational engagement with the output gear; and
a second input gear assembly disposed in rotational engagement with the first input gear and the output gear; and
a second motor coupled to the second input gear assembly, the second motor configured to modulate a rotational speed of the output gear by modulating a speed of the second input gear assembly.

9. The system of claim 8, wherein the first motor is a fixed speed synchronous motor.

10. The system of claim 8 further including a variable frequency drive coupled to the second motor, the variable frequency drive configured to vary a speed of the second motor.

11. The system of claim 8, wherein the second motor is configured to rotate bi-directionally.

12. The system of claim 8, wherein the second motor is configured to rotate in a direction of rotation of the first motor to increase a rotational speed of the output gear.

13. The system of claim 8, wherein the second motor is configured to rotate in a direction opposite to a direction of rotation of the first motor to decrease a rotational speed of the output gear.

14. The system of claim 8, wherein the second motor is configured to modulate a speed of the output gear within a range of ±30% of a speed pre-determined by the fixed speed prime mover.

15. The system of claim 8, wherein the second input gear assembly is an epicyclic planetary gear set comprising two or more planet gears disposed in mesh with the first input gear and the output gear respectively.

16. A method of modulating a rotational speed of a driven equipment, the method comprising:
driving a first input component of a differential at a speed pre-determined by a fixed speed prime mover;
rotating a power output component of the differential at the speed pre-determined by the driven first input component, the power output component coupled to the driven equipment; and
driving a second input component disposed in rotational engagement with the first input component and the power output component by a variable speed prime mover such that the speed of the power output component pre-determined by the driven first input component is modulated.

17. The method of claim 16, wherein driving the second input component comprises rotating the second input component in a direction of rotation of the fixed speed prime mover to increase the speed of the power output component.

18. The method of claim 16, wherein driving the second input component comprises rotating the second input component in a direction opposite to a direction of rotation of the fixed speed prime mover to decrease the speed of the power output component.

19. The method of claim 16 further comprising modulating a rotational speed of the power output component by the second input component within a range of ±30% of the speed pre-determined by the fixed speed prime mover.
